(19) United States
(12) Patent Application Publication
(10) Pub. No.: US 2016/0049629 A1
(43) Pub. Date: Feb. 18, 2016

(54) BUS BAR

(71) Applicant: Mitsubishi Electric Corporation, Tokyo (JP)

(72) Inventor: Kensaku MATSUDA, Tokyo (JP)

(73) Assignee: Mitsubishi Electric Corporation, Tokyo (JP)

(21) Appl. No.: 14/778,647

(22) PCT Filed: Apr. 16, 2013
(86) PCT No.: PCT/JP2013/061303

§ 371 Date: Sep. 21, 2015

(51) Int. Cl. H01M 2/20

(52) U.S. Cl. CPC H01M 2/206; H01M 2220/20

(57) ABSTRACT

In a bus bar that connects a plurality of terminals of a plurality of power modules including the terminals having screw holes for fixing screws on one surface, the plurality of power modules being disposed in parallel, and that is fixed to the power modules by aligning through-holes provided in the bus bar with the screw holes and inserting the screws into the through-holes and the screw holes. A terminal contact section in contact with the terminals has a first thickness that is smaller than a second thickness of another region, and the first thickness is a thickness with which the bus bar is deformable by fixing the screws such that a contact surface of the bus bar in contact with the terminals comes into close contact with the terminals.

### FIELD

The present invention relates to a bus bar.

### BACKGROUND

In a main circuit module that controls a large current, a reduction in size is in progress and the current density tends to increase. Therefore, it is required to ensure an insulation distance between adjacent terminals provided in the main circuit module. However, in a main circuit module requested to have a high current amount, the interval between terminals is reduced to a necessary insulation distance. There is an upper limit in rating per main circuit module. For obtaining a large capacity, modules is used in parallel in order to have a necessary current value.

In a case that a plurality of main circuit modules are used in parallel, the terminals of the main circuit modules are connected by a bus bar generally made of metal, such as copper. Because the terminals are provided close to each other as explained above, the thickness of the bus bar tends to increase to increase the current value. If the bus bar has a larger thickness, the bus bar has a higher hardness and, in addition, flatness cannot be ensured during machining. As a result, the contact area in contact with the terminals of the main circuit modules cannot be sufficiently ensured, leading to an increase in contact resistance and an increase in heat generation in terminal sections.

Incidentally, as a bus bar that connects electrode terminals of battery cells of a battery module used for an electric automobile or a hybrid automobile, there has been proposed a bus bar having a structure in which deforming sections are erected substantially perpendicularly on the battery cell side. The deforming sections are provided at the circumferential edges of the through-holes into which male screws provided in the battery cells can be inserted (see, for example, Patent Literature 1). Such deforming sections are formed by punching the through-holes after drawing and can be deformed with small force generated when nuts are tightened. As a result, it is possible to sufficiently ensure contact between the bus bar and the electrode terminals among a plurality of battery cells that are difficult to set so that they have the same height.

### CITATION LIST

### Patent Literature

Patent Literature 1: Japanese Patent Application Laid-Open No. 2012-113834

### SUMMARY

### Technical Problem

However, with the technology described in Patent Literature 1, the contact between the bus bar and the electrode terminals of the battery cells can only have an area to the extent that is obtained by crushing the deforming sections provided such that they project perpendicularly to the bus bar. In a case of a bus bar having a sufficient large thickness, it is difficult to crush projection sections using screws. That is, there is a problem in the conventional technology in that the contact area between the bus bar and the electrode terminals cannot be sufficiently ensured.

The present invention has been devised in view of the above and it is an object of the present invention to obtain a bus bar that connects terminals of a plurality of power modules, the bus bar being capable of ensuring a contact area with terminals of the power modules.

### Solution to Problem

According to an aspect of the present invention in order to achieve the object, there is provided a bus bar that connects a plurality of terminals of a plurality of power modules including the terminals having holes for fixing fixtures on one surface, the plurality of power modules being disposed in parallel, and that is fixed to the power modules by aligning through-holes provided in the bus bar with the holes and inserting the fixtures into the through-holes and the holes, wherein a terminal contact section in contact with the terminals has a first thickness that is smaller than a second thickness of another region, and the first thickness is a thickness with which the bus bar is deformable by fixing the fixtures such that a contact surface of the bus bar in contact with the terminals comes into close contact with the terminals.

### Advantageous Effects of Invention

The present invention has an effect that, even if the bus bar has a larger thickness and flatness of the lower surface (on the contact surface side with the terminals) is not ensured, it is possible to ensure a contact area with the terminals of the power modules and it is possible to reduce the contact resistance between the bus bar and the terminals of the power modules. The present invention also has an effect that it is unnecessary to uselessly increase the thickness of the bus bar to ensure heat radiation.

### BRIEF DESCRIPTION OF DRAWINGS

FIG. 1 is a perspective view showing an example of the configuration of power modules including a bus bar according to an embodiment.

FIG. 2 is a cross-sectional view taken along the longitudinal direction of the bus bar according to the embodiment.

FIG. 3 is a cross-sectional view showing another structure of the bus bar according to the embodiment.

### DESCRIPTION OF EMBODIMENTS

Exemplary embodiments of a bus bar according to the present invention are explained in detail below with reference to the accompanying drawings. Note that the present invention is not limited by the embodiments.

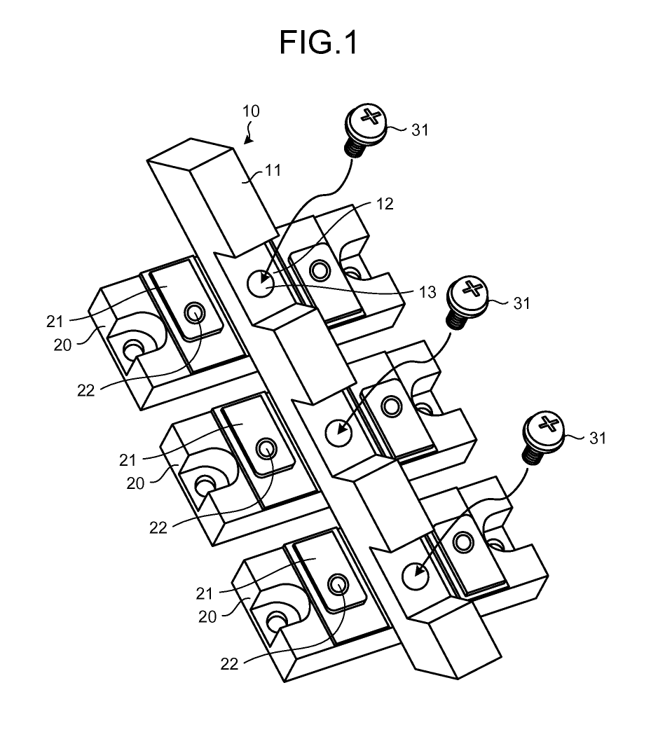

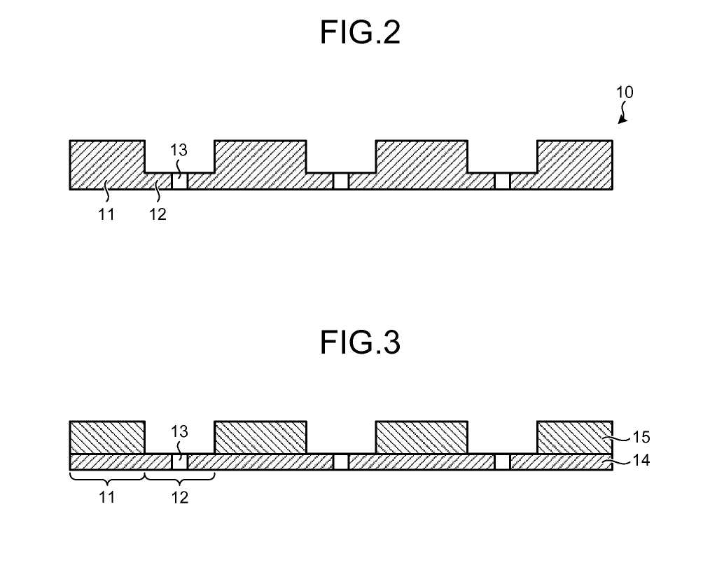

FIG. 1 is a perspective view showing an example of the configuration of power modules including a bus bar according to an embodiment. FIG. 2 is a cross-sectional view taken along the longitudinal direction of the bus bar according to the embodiment.

A plurality of terminals 21 are provided on the upper surface of power module 20 in which large current switching element is modularized. A screw hole 22 used for fixing a bus bar 10 is provided in each of the terminals 21. The terminals 21 are separately disposed at a predetermined insulation distance.

The bus bar 10 is provided to connect the terminals 21 of the power modules 20 disposed in parallel. In the bus bar 10, through-holes 13 are provided corresponding to the screw holes 22 of the power modules 20 disposed in parallel. Regions (hereinafter referred to as contact regions) 12 provided with the through-holes are set to have a first thickness. An allowable current can be fed into regions 11 other than the contact regions 12. The regions 11 are set to have a second thickness larger than the first thickness thorough which heat can be radiated. The bus bar 10 is placed on the terminals 21 disposed on the upper surfaces of the power modules 20, such that the screw holes 22 of the terminals 21 are aligned with the through-holes 13 of the bus bar 10. The bus bar 10 is fixed by screws 31 which are fixing members. When the bus bar 10 is fixed, the contact regions 12 having the first thickness are deformed (bent) by screwing so as to have shapes in accordance with the position or the shape of the terminals 21 provided under the bus bar 10. Therefore, the contact regions 12 come into close contact with the terminals 21 of the power modules 20.

The first thickness of the contact regions 12 of the bus bar 10, which is the thickness of the contact portions in contact with the terminals 21, is set to a thickness with which the bus bar 10 is deformable such that a non-contact portion is not formed between the rear surface of the bus bar 10 and the terminals 21 when the bus bar 10 is fixed by the screws 31. Therefore, even if the flatness of the machined surface of the entire rear surface of the bus bar 10 is not ensured, it is possible to ensure a contact area between the bus bar 10 and the terminals 21 of the power modules 20.

The bus bar 10 as above is obtained by pressing or cutting a belt-like member that has length and width substantially the same as those of the bus bar 10 and has the second thickness as a whole, such that the belt-like member has the first thickness in portions in contact with the terminals 21 of the power modules 20. A metal material or an alloy material such as copper, a copper alloy, and stainless steel can be used for the bus bar 10.

Note that the bus bar 10 shown in FIG. 2 has an integrally formed structure. However, the bus bar 10 may not have such an integrally formed structure. FIG. 3 is a cross-sectional view showing another structure of the bus bar according to the embodiment. In this example, the bus bar 10 has a structure in which a first belt-like member 14 and a second belt-like member 15 are fixed by such a method as welding in regions other than portions in contact with the terminals 21 of the power modules 20. The first belt-like member 14 has the first thickness and is made of a metal material or an alloy material. The second belt-like member 15 has a width same as the width of the first belt-like member 14 and has a third thickness. As a result, the bus bar 10 has the first thickness in the contact regions 12 in contact with the terminals 21 of the power modules 20 and has the second thickness, which is a sum of the first thickness and the third thickness, in the regions 11 other than the contact regions 12. The bus bar 10 having such a structure may be used.

Note that the size of the contact regions 12 having the first thickness can be adjusted according to an allowable current required of the bus bar 10. For example, in a case that the bus bar 10 is used for connecting the power modules 20 having a high allowable current, the size of the contact regions 12 is adjusted such that the area of the contact regions 12 increases. When the bus bar 10 is used for connecting the power modules 20 which are not required to have a very high allowable current, the size of the contact regions 12 is adjusted such that the area of the contact regions 12 decreases.

In the embodiment described above, the bus bar 10 is provided to connect the terminals 21 on the upper surfaces of the power modules 20 disposed in parallel. In the regions 11 which are not in contact with the terminals 21, the bus bar 10 has the second thickness with which an electric current requested of the power modules 20 can be fed. In the contact regions 12 which are in contact with the terminals 21 of the power modules 20, the bus bar 10 has the first thickness with which the bus bar 10 is deformable to come into close contact with the terminals 21 of the power modules 20 when being screwed. Consequently, there is an effect that, even if the bus bar 10 has a larger thickness and flatness of the lower surface (the contact surface side with the terminals 21) is not ensured, it is possible to ensure the contact area with the terminals 21 of the power modules 20 and it is possible to reduce the contact resistance between the bus bar 10 and the terminals 21 of the power modules 20. There is also an effect that it is unnecessary to uselessly increase the thickness of the bus bar 10 to ensure heat radiation.

### INDUSTRIAL APPLICABILITY

As explained above, the bus bar according to the present invention is useful for connecting terminals of power modules.

### REFERENCE SIGNS LIST

10 bus bar,
12 contact regions,
13 through-hole,
14 first belt-like member,
15 second belt-like member,
20 power module,
21 terminal,
22 screw hole,
31 screw,

1. A bus bar that connects a plurality of terminals of a plurality of power modules including the terminals having holes for fixing fixtures on one surface, the plurality of power modules being disposed in parallel, and that is fixed to the power modules by aligning through-holes provided in the bus bar with the holes and inserting the fixtures into the through-holes and the holes, wherein
a terminal contact section in contact with the terminals has a first thickness that is smaller than a second thickness of another region, and
the first thickness is a thickness with which the bus bar is deformable by fixing the fixtures such that a contact surface of the bus bar in contact with the terminals comes into close contact with the terminals.

2. The bus bar according to claim 1, wherein the terminal contact section and the another region are integrally formed.

3. The bus bar according to claim 1, comprising:
a first belt-like member having the first thickness; and
a second belt-like member provided in a region other than the terminal contact section of the first belt-like member and connected to the first belt-like member by welding such that a sum of thicknesses of the second belt-like member and the first belt-like member is the second thickness.

4. The bus bar according to claim 1, wherein the terminal contact section having the first thickness has an area adjusted according to magnitude of an allowable current fed to the bus bar.
